(19) United States
(12) Patent Application Publication
(10) Pub. No.: US 2004/0133431 A1
(43) Pub. Date: Jul. 8, 2004

(54) Integrated internet-based orthotic shoe insole marketing and production system

(76) Inventors: Toma Udiljak, Zagreb (HR); Karlo Obrovac, Zagreb (HR); Igor Istef, Zagreb (HR); William Malcolm Granberry, Houston, TX (US)

Correspondence Address: CONLEY ROSE, P.C., P. O. BOX 3267, HOUSTON, TX, 77253-3267, US

(21) Appl. No.: 10/062,855

(22) Filed: Jan. 31, 2002

Related U.S. Application Data
(60) Provisional application No. 60/265,587, filed on Jan. 31, 2001.

(51) Int. Cl. G06F 17/60

(52) U.S. Cl. 705/1

(57) ABSTRACT

An orthotic insole marketing and production system, comprising a means for receiving orthotic insole orders, each order comprising user information, scanned foot images, and perhaps a prescription from a medical practitioner. A conversion utility converts the scanned foot images into a three dimensional orthotic insole model, which may be manipulated with a modeling utility. A postprocessing utility generates fabrication instructions based on the manipulated orthotic insole model. The fabrication instructions are sent to a milling device that interprets the fabrication instructions to create a physical reproduction of the manipulated orthotic insole model, which is subsequently delivered to the user for use as an orthotic insole. The ordering process may be facilitated with the use of a foot scan software executable by customers to collect order information and aid users in scanning foot images. The foot scan software program creates and transmits orthotic insole orders to the production system.

### CROSS-REFERENCE TO RELATED APPLICATIONS

This application claims priority to provisional patent application, serial No. 06/265,587, which is hereby incorporated by reference herein.

### STATEMENT REGARDING FEDERALLY SPONSORED RESEARCH OR DEVELOPMENT

Not applicable.

### BACKGROUND OF THE INVENTION

1. Field of the Invention

The present invention generally relates to orthotic shoe insoles. More particularly, the present invention relates to a system for receiving and filling orders for orthotic inserts over a network using an integrated production database and manufacturing system.

2. Background of the Invention

Foot insoles are that portion of the interior of a shoe that immediately contacts the sole of the foot. While shoes are meant to support and cushion the foot, the insole can also provide support. In such a case, the insole may be referred to as an orthotic insole. The word orthosis comes from the Greek version of the word, which means ‘to make straight’. In medical terminology, this term refers to an orthopedic appliance that is used externally to support or correct impaired joints or limbs. Hence, a foot orthosis refers to a device placed inside a shoe that cushions or supports the foot for the purpose of correcting or protecting some portion of the wearer's body. The amount of support that an orthotic can provide depends on the rigidity of the materials that are used. In general, very rigid materials are more supportive but also less comfortable and often take an adjustment phase before they can be tolerated for long periods of time. Conversely, soft materials are much more comfortable but cannot support as well.

Given this broad spectrum of material applications for corrective and supportive orthotics, it is easy to see how manufacturing expertise becomes important. Conventional methods of designing and manufacturing orthotic shoe inserts or insoles present a broad spectrum of approaches. On the one hand, many prescription orthotics are developed using labor-intensive manual techniques. For instance, a foot model might be generated using a plaster cast, a deformable sponge, or even an ink print. The first two offer the advantage of yielding a 3-dimensional model of the foot while the latter offers a simple, yet speedy way to permanently capture a 2-D imprint of a foot shape. Yet, despite the advantages offered by these manual imprint capture techniques, they are only moderately helpful to a manufacturer whose task is to create an insole that perfectly matches the contours of individual feet. The insole designer or manufacturer must mentally transfer the foot mold or image to the workpiece. The manufacturing process is often iterative with wedges or pads added to the orthotic to alter its fit or function. Furthermore, errors cannot generally be undone. If a recess is cut in the wrong location or if too much material is trimmed from a surface, the insole is usually scrapped and the process repeated.

The above problems are exacerbated if the insole is designed for prescription use in injury rehabilitation or reduction of foot pain. Prescription orthotic designs generally incorporate additional information about localized forces and pressure distributions present during the patient's gait or walk. Insole manufacturers must consider the pressure profiles from modem foot pressure measurement systems in conjunction with the patient's foot model.

At the other end of the design spectrum are manufacturers that use high-end laser scanners to create a digitized 3-D model of a foot. While certainly accurate, this technique may be cost prohibitive due to the large equipment expense and the startup costs are inevitably passed along to the consumer in the way of more expensive insoles.

Therefore, it would be desirable to provide an efficient computer aided design and manufacturing (CAD/CAM) solution that simplifies the orthotic creation process by enabling an efficient interface between all production phases. This includes an initial phase of capturing a digitized, three-dimensional model of a patient's foot. A valuable byproduct of the digitization of the design process is that the whole process may be automated and the product may be offered for sale over the internet. Thus, the entire process may advantageously offer a faster, more inexpensive, and more accurate means of creating and delivering orthotic shoe insoles.

One method of capturing a digitized model of a customer's foot has been proposed by White in U.S. Pat. No. 5,237,520. The system described in White uses an electro-optical scanner to capture a two dimensional image of a foot for conversion to a three-dimensional (3D) model of that same foot. The scanned foot model is subsequently used to create a custom shoe last or locate a pre-existing shoe last for custom-sized shoes or boots. Some limitations of the White system are that there is no provision for altering or manipulating the 3-D foot or insole models or for adding prescription features to the shoe insole to create a true orthotic.

It would, therefore, also be desirable to include a 3-D orthotic production tool that is capable of importing raw 3-D models from an electro-optic scanner of the type of proposed by White, and that is further capable of manipulating the model to create a custom orthotic for transmission to manufacturing equipment. In addition, it would also be desirable to provide an efficient means of transmitting customer data (including personal information as well as foot models) from the customer location to a centralized manufacturing, ordering, and distribution center.

### BRIEF SUMMARY OF THE INVENTION

The problems noted above are solved in large part by an orthotic insole marketing and production system, comprising a means for receiving orthotic insole orders, each order comprising user information and scanned foot images. The orthotic insole orders optionally include a prescription based on a diagnosis from a medical practitioner. The system also includes a conversion utility for converting the scanned foot images into a three dimensional orthotic insole model as well as a modeling utility for manipulating the three dimensional orthotic insole models. Also included are a postprocessing utility for generating fabrication instructions from the manipulated orthotic insole model and a fabrication device that interprets the fabrication instructions to create a physical reproduction of the manipulated orthotic insole model. The preferred fabrication device is a CNC milling machine that recognized cutting instructions from the postprocessing utility. The physical reproduction created by the milling is subsequently finalized by cleaning, trimming and packaging for delivery to the user as a custom orthotic insole.

An integral part of the marketing and production system is a foot scan software program executable by orthotic insole customers to collect order information and aid users in scanning foot images. The foot scan software program creates and transmits orthotic insole orders to the system receiver. Preferably, the software program packs all order information and scanned images into a single file prior to transmitting the orthotic insole order. The marketing and production system includes an unpack utility for extracting order information and scanned images from these packed orthotic insole orders. The system also includes a production database for storing records of each orthotic insole customer. The unpack utility submits order information and scanned images to the production database.

Another aspect of the marketing and production system is a public network accessible by customers. The network is preferably embodied as an internet website that provides information on ordering orthotic insoles and also provides access to the foot scan software. Orthotic insole orders may be transmitted by the foot scan software to the website or they may be transmitted by the foot scan software to a private network within the orthotic insole production system.

The process of designing and manufacturing the custom orthotics begins by receiving into a computer system an order for custom orthotic insoles; each order comprising scanned images of a patient's foot and instructions on fabricating the orthotic insole. Once received, the scanned images are converted into three dimensional orthotic insole computer models. Features may be added to the orthotic insole computer model according to the instructions for fabricating the orthotic insole. Fabrication instructions for creating a physical replica of the orthotic insole computer model are then created and interpreted by a manufacturing device to create the physical replica. The image to 3D model conversion includes converting the scanned foot images into a three dimensional foot computer model and then using this foot model to create the top surface of the orthotic insole computer model.

A patient record is created in a production database for each customer that has placed an order for custom orthotic insoles. All order information is preferably stored with the corresponding patient record. Furthermore, all patient record information within the production database is viewable using a production database explorer software program.

Other optional features of the manufacturing and production system include the ability to receive data from a foot pressure measuring device reflecting pressure distributions on the foot of a customer ordering orthotic insoles. Other data that can be received include data from a medical imaging device reflecting the internal structure of a customer's foot as well as data from a laser scanning device reflecting a 3D model of the exterior of a customer's foot. All of this data can be used during the design and manipulation of the orthotic insole model. It may also be possible to overlay the data onto the 3D insole model.

Ordering the custom orthotic insoles involves acquiring computer images of a foot using an electro-optic scanner and transmitting the images and custom fabrication instructions to the orthotic insole manufacturer. The scanning and ordering process may be facilitated by using a foot scan software program available from the orthotic insole manufacturer website. The foot scan software permits the user to input user information in response to queries from the software and to acquire computer foot images by following software instructions. The order for custom orthotic insoles can be submitted directly from the foot scan software or by emailing an order file generated by the foot scan software to the orthotic insole manufacturer.

The order may be submitted by the end user or, in the case of prescription insoles, the order is placed for the end user by an authorized practitioner. In this latter case, the authorized practitioner is likely a medical doctor and the custom fabrication instructions are in the form of a prescription generated in response to a medical diagnosis.

### BRIEF DESCRIPTION OF THE DRAWINGS

For a detailed description of the preferred embodiments of the invention, reference will now be made to the accompanying drawings in which:

FIG. 1 shows a simplified representation of the different methods of ordering an orthotic insole from an orthotic provider using the preferred marketing and production system;

FIG. 2 shows a representative computer system coupled to an electro-optic scanning device that can be used to generate images of a customer's foot in ordering a custom orthotic insole;

FIG. 3 shows a schematic representation of the preferred orthotic marketing and production system;

FIG. 4 shows a flowchart describing the different methods of ordering a non-prescription orthotic insole;

FIG. 5 shows a screen capture of the preferred foot sizing software used in ordering a prefabricated orthotic insole;

FIG. 6 shows a flowchart describing the function of the preferred foot scan software used in capturing images of a customer's foot;

FIG. 7 shows a simplified representation of the menu structure of the preferred website through which customers may order custom orthotic insoles;

FIG. 8 shows a screen capture of the preferred orthotic insole production database management software;

FIG. 9 shows a simplified representation of the preferred orthotic insole database management software functionality;

FIG. 10 shows a simplified representation of the preferred orthotic production schedule network;

FIG. 11 shows a simplified representation of the preferred orthotic insole designer software functionality;

FIG. 12 shows a simplified representation of the preferred orthotic insole modeler software functionality;

FIG. 13 shows a screen capture of the preferred orthotic insole designer software;

FIG. 14 shows a screen capture of the preferred orthotic insole modeler software;

FIG. 15 shows a screen capture of the preferred orthotic insole production database explorer software;

FIG. 16 shows a simplified representation of the contents of individual records in the preferred production database explorer software; and

FIG. 17 shows a screen capture of an individual record in the preferred production database explorer software.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the terms “orthotic” and “orthotic insoles” are intended to be interchangeable and are further intended to describe a footwear insert capable of providing corrective support to a wearer's feet, legs, back, or other body part.

### DETAILED DESCRIPTION OF THE PREFERRED EMBODIMENTS

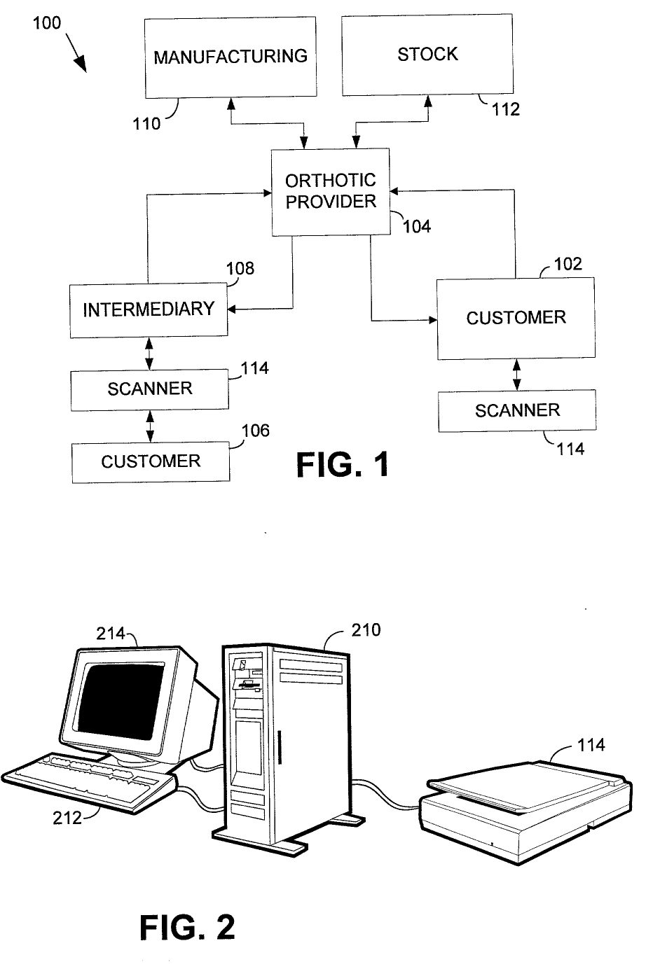

Referring now to FIG. 1, the preferred orthotic shoe insole marketing and production system 100 permits customers to order and receive orthotic insoles using at least two different approaches. In each case, the customer ultimately receives the insoles from the same source, but the methods used to order and receive the insoles differ substantially. The first method, represented by customer 102, involves ordering the insoles directly from the orthotic provider 104, preferably through an internet website (not specifically shown). In the second method, customer 106 orders the custom orthotics through an intermediary 108 such as a podiatrist, a doctor, or some other practitioner qualified to prescribe custom orthotic insoles. In either case, the orthotic provider 104 receives the order for custom insoles and fills the order by either manufacturing 110 the insole according to the prescription or by locating a stock, off the shelf (OTS) orthotic 112 that most closely matches the customer's feet. It should be noted that whereas customer 102 may order orthotic inserts directly from provider 104, these inserts are necessarily non-prescription inserts. In order to obtain corrective, prescription orthotics, the customer must visit a qualified doctor for diagnosis to determine if prescription insoles are warranted.

A key element of the preferred marketing and production system 100 is the ability to transmit an image of the customer's feet to the orthotic provider 104 to aid in manufacturing the custom insoles. As such, an initial step in ordering custom orthotics is to scan the customer's foot or feet using a conventional electro-optic scanning device 114. The resulting images are subsequently transmitted to the orthotics provider 104 along with pertinent customer information. The scanned images are then used by the orthotics provider 104 to create a three-dimensional (3D) insole model that can be manipulated and modified and ultimately used to create machining instructions for fabricating the insoles on a numerically controlled milling machine (not shown).

Referring now to FIG. 2, a suitable scanning device 114 capable of capturing foot images in accordance with the preferred embodiment is shown. The scanning device 114 is preferably coupled to a personal computer 210 which, at a minimum, comprises a keyboard input device 212 and a video display device 214 to facilitate user interaction with the computer 210. The computer 210 is preferably configured to execute proprietary foot scan software that can be obtained from the orthotics provider 104. The personal computer 210 is preferably an IBM PC compatible computer running a Microsoft operating system, although other computers such as those offered by Apple or Sun and other operating systems such as Red Hat Linux will suffice as long as they are compatible with scanning device 114 and the preferred foot scan software, which is described in further detail below. In addition, the preferred scanning device 114 should be TWAIN compatible to facilitate communication with the preferred foot scanning software.

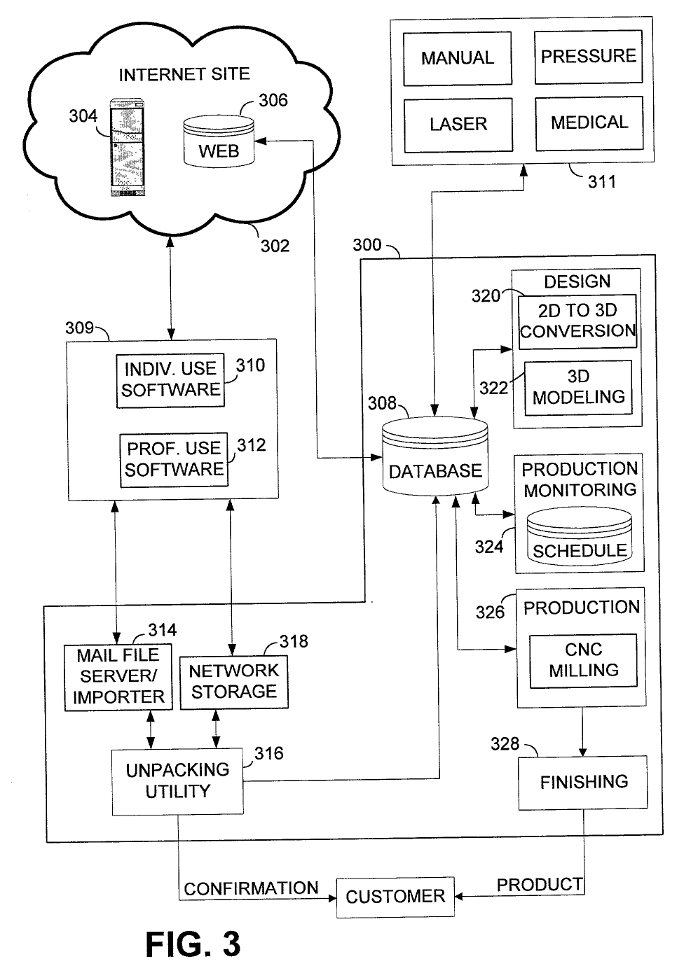

Images acquired with the preferred scanning device 114 are subsequently used in the preferred orthotic marketing and production system 100 shown in FIG. 3. The central hub of the preferred embodiment is the manufacturing and production database center 300. This manufacturing and production database center 300 is tied closely with a public network site 302, which is preferably embodied as an internet website accessible via standard or secured hypertext transfer protocols (http or https). The manufacturing and production database center 300 and internet website 302 may be implemented on computer servers 304 at the same location or they may be housed in distinctly separate locations. The manufacturing and production database center 300 and internet website 302 each preferably comprise a database (306 and 308, respectively) to store customer orders, information, and data files. Customer orders and related information are preferably transmitted to the central database 308 from one of several different sources and via different methods.

A first source 309 of customer orders (and related information) is from users of the proprietary foot scan software 310, 312. Two different versions of the foot scan software are contemplated: an individual use version 310 for ordering non-prescription insoles and a professional use version 312 for ordering prescription insoles from a qualified intermediary 108. Each version of the software 310, 312 can preferably be downloaded from the internet website 302 using a suitable transfer protocol such as HTTP or file transfer protocol (FTP). Each version 310, 312 provides users with a step-by-step instruction wizard that guides users through the process of scanning the customer's feet (or foot) and transmitting the acquired images to the orthotics provider 104. The main difference between the two versions of the software 310, 312 derives from the fact that the professional version 312 requires a qualified intermediary to acquire and transmit foot images and customer orders to the orthotics provider 104. In the preferred embodiment, podiatrists or other doctors may enter into a cooperative agreement with the orthotics provider 104 to order direct from the orthotics source. Hence, ordering prescription insoles using the professional version of the software 312 requires prior client authentication and verification to prevent unauthorized prescriptions from being filled.

In accordance with the preferred embodiment, there are several methods of transmitting orthotic orders and foot images to the central database 308 from consumers 309 using the preferred foot scan software 310, 312. In one method, the orders and related data and images are uploaded to the central database 308 through the internet website 302. This particular method presumes that users are connected to the internet while foot images are acquired. Thus, once the images are scanned using scanner 114, the foot scan software 310, 312 transmits the images to the web database via an FTP, HTTP, or some other transfer protocol connection. It should be noted that for this particular transmission method, the foot scan software may be implemented using a web page scripting language that loads and runs on the customer's PC 210 each time the customer visits the internet website. Such a solution may be simpler and more user-friendly than a solution requiring a separate download and installation of foot scan software 310, 312.

Furthermore, it may also be possible for users that are skilled in the use of flatbed scanners to make a scan of their foot or feet using imaging software that is already loaded on their computer. Guidelines for proper resolution, color depth, and tips for acquiring optimal scans are preferably available from the internet website 302 or from some other marketing device such as a pamphlet or an advertisement. Users may use these guidelines to acquire scans on their own and submit these scans to the production database using any of the methods described herein. Thus, while the use of the foot scan software 310, 312 aids in creating an automated order submission, there are certainly other methods of submitting order requests and related foot scans, as those skilled in the art will undoubtedly understand.

A second method of transmitting customer orders 309 generated by the foot scan software is via a standard email protocol, such as the simple mail transfer protocol (SMTP) or IMAP protocol. In the preferred embodiment, a standard POP3 server 314 is used by the manufacturing and production database center 300 to receive email orders from customers using the foot scan software 310, 312. It is envisioned that the foot scan software will combine customer information and foot images into a single, packed file that can be emailed to the manufacturing and production database center 300 as a standard email attachment. This particular order submission method allows customers without a direct internet connection to run the foot scan software 310, 312 and save the resulting images and information to a local PC hard drive and email the order at some later time when an internet connection is available.

Email orders are preferably separated from other emails using a mail filter utility 314 that specifically searches for packed order files in incoming emails. Once received, the orders are extracted from the email message, unpacked 316, and submitted to the central database 308. The unpacking utility 316 and mail filtering utility 314 preferably work together to ensure the validity of orders and are also configurable to transmit a confirmation email to notify customers that their order was received and properly entered.

Yet another method of transmitting customer orders 309 generated by the foot scan software is through a direct network connection. Security can be maintained by limiting this transmission method to authorized customers using the professional version of the foot scan software 312. As mentioned above, authorized clients running the professional version of the software 312 have preferably entered into an insole ordering agreement and may be granted an access point into the manufacturing and production database center 300 network. Access may be granted via a dial-up RAS type of account or some other pseudo-permanent network connection. Another solution may include a password protected FTP account. Those skilled in the art will recognize the various possible network connections that can satisfy the requirements described herein. Customers using this particular ordering method will preferably transmit all order information and scanned images directly to a temporary network storage directory 318 that may be periodically checked for new orders. If the order information is packed using the foot scan software 312, the unpacking utility 316 described above may be used to extract and submit the order to the central database 308. As before, the unpacking utility can be configured to send a confirmation indicating that the order has been located and submitted.

Referring still to FIG. 3, in addition to the data and image sources just described, customer information can also be acquired from external, third party sources 311 such as digital foot pressure measurement devices, laser scanning devices, or from medical data files. Examples of each of these are discussed below. Furthermore, customer information can also be entered manually and submitted after the original order is placed. For instance, updated delivery instructions, contact information, or other information that was unavailable when the insoles were ordered may need to be entered into the database. The preferred embodiment permits data from each of these auxiliary data sources to be correlated with the appropriate customer and attached to the patient record to aid in production and customization of the orthotic insoles.

Examples of compatible foot pressure measurement device files include *.LST files from the EMED and PEDAR measuring devices by Novel and *.ASF files from Tekscan measuring devices. Similarly data files with the *.DAT and *.GEO extensions generated by 3D laser scanners can also be attached to a patient record within the central database 308. Medical data files conforming to the digital imaging and communication in medicine (DICOM) format from medical imaging devices such as CT or MRI scanners may also be imported into the central database 308. It should also be noted that foot scan images of various file types, including *.GIF, *.BMP, *.JPG, and *.TIF are all fully compatible with the preferred embodiment of the orthotic production system. It is intended that other comparable pressure measurement, laser scan, and image file types known by those skilled in the art be within the scope of the description contained herein.

Once the appropriate foot images are uploaded into the central production system database 308, the images are preferably converted into a 3D model with the Insole Designer 320. The resulting 3D model is then manipulated to create a virtual insole using an Insole Modeler 322. The Insole Modeler 322 is also configured to generate machining instructions for fabricating the custom orthotic insoles on a CNC milling machine 326. After the machining process 326, all insoles are put through a finishing process 328 for final trimming, gluing, and packaging prior to product shipment. Each of these features of the orthotic insole production process is discussed in further detail below. At each stage of the production process, the preferred production system provides a production schedule monitoring function 324 that allows customers or service representatives to query the central database 308 for the status of any order.

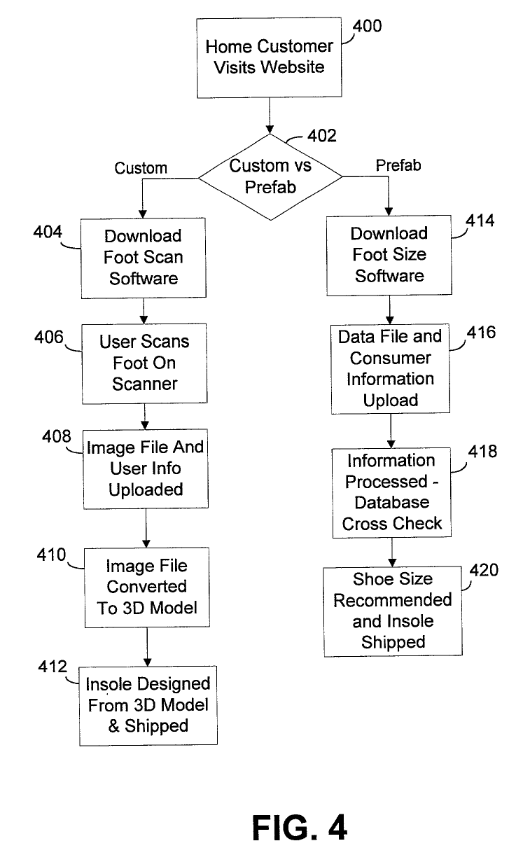

Referring now to FIG. 4, a flowchart describing the different methods of ordering a non-prescription orthotic insole is shown. Individual customers visiting 400 the internet website 302 can preferably choose 402 between a custom orthotic insole or a semi-custom, prefabricated insole. The first step 404 in ordering a custom, non-prescription insole is to download and install the foot scan software available from the internet website 302. Once installed, the foot scan software will walk the customer through the process 406 of scanning his or her feet using a conventional scanner 114. Once the images are acquired, the customer can upload 408 the images and user information to the orthotic production database using any of the appropriate methods described above. The orthotic manufacturer then takes the foot images and converts them into 3D models 410, which are subsequently used to create insole models and ultimately, a finished insole product that is shipped 412 directly to the customer.

It should be noted that this particular branch of the flowchart in FIG. 4 parallels the process followed by podiatrists or other qualified practitioners wishing to order custom orthotics for patients. As mentioned, ordering prescription insoles requires advance authorization and perhaps establishment of a unique client identifier. However, once authorization is established, the process for ordering custom, prescription insoles becomes virtually identical to that shown in FIG. 4.

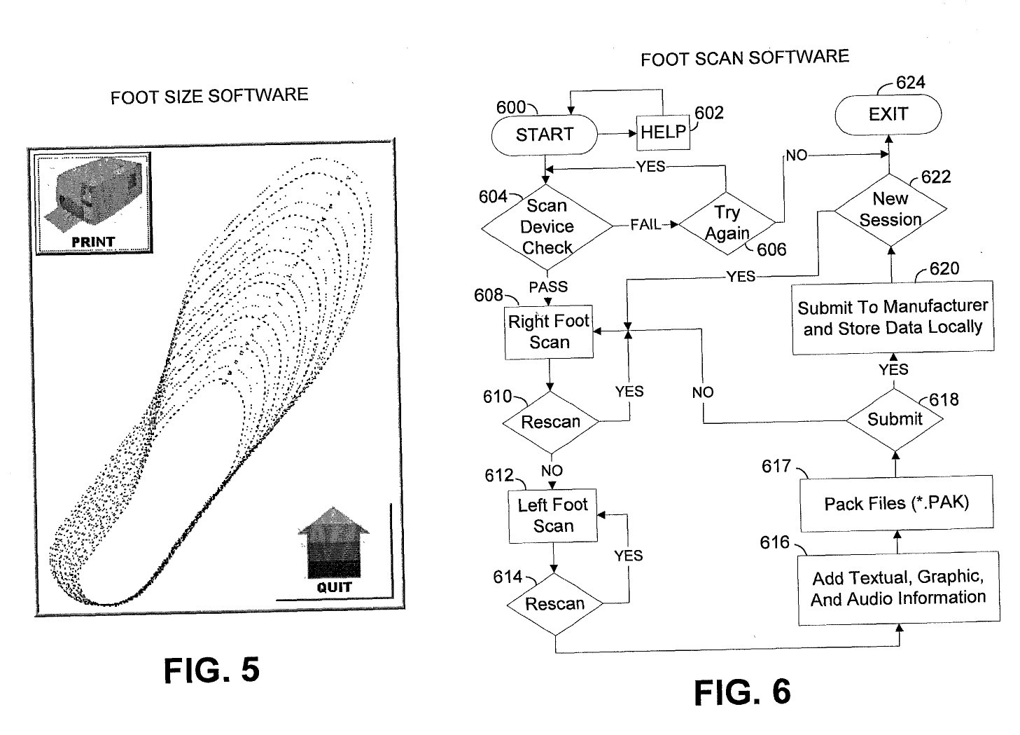

If, on the other hand, the customer prefers a pre-fabricated, OTS insole (or perhaps if the customer does not have access to a flatbed scanner 114), the customer can download 414 the foot size software available from the internet website 302. The foot size software is a simple utility that allows customers to measure their foot size and correlate their foot size with an appropriate insole size. The software prints out a sheet of paper with insole outlines of different sizes (See FIG. 5) so the customer can find the closest match to his or her feet. The customer can then enter and upload 416 the appropriate insole size as well as the remaining order information to the production database, where the orthotic insole provider performs a statistical comparison to the model database and selects the appropriate insole for the customer 418. The database can also include information about various shoe manufacturers and shoe designs (lasts) so the insoles can be shaped to fit properly in the customer's actual shoes. This particular feature is likely justified by the fact that there is some inconsistency in shoe sizing across shoe manufacturers. Based on the customer model and database search, the manufacturer ships 420 the appropriate semi-custom insole to the customer. In ordering either custom or prefabricated insoles, the customer is able to order and receive specialized insoles with only a minimal amount of time and effort.

As noted, the lack of access to a flatbed scanner may be one reason customers choose to order pre-fabricated insoles. If this is the case, customers may still be able to order custom insoles by using a conventional foam box imprint method to capture an impression of their feet. The preferred internet website 302 will preferably indicate this option to those customers who download the foot size software 414. If a customer elects to pursue this option, foam boxes are sent to the customer with instructions on how to create foot impressions in the foam. Once the impressions are created, the customer sends the foam boxes back to the orthotics provider 104 where the foam impressions are scanned in to generate the necessary images. Subsequent image processing and insole fabrication methods as described herein may then be used.

Referring now to FIG. 6, the basic functionality of the foot scan software is shown in the form of a simple flow chart. Once initiated 600, the foot scan software offers tutorial and help information 602 describing the scanning process, scanner settings as well as tips and warnings for proper foot scanning. Prior to scanning, the foot scan software checks 604 for the existence and status of a flatbed scanner. If this initial check fails, the software will ask the user to check the appropriate connections and power and to try again 606. The user may then elect to quit the program or recheck the device.

If the software positively detects the scanner device, the user is prompted to scan their right foot. Once started, the software activates the scanner driver to acquire a compressed, grayscale image of the right foot 608. The image is stored temporarily onto the PC hard drive and displayed for the user to review. The scanner is then reset for a new scan and the user is prompted to accept the scanned image or rescan the right foot 610. If the image is acceptable, the user can repeat the process for the left foot 612, 614. In the event the user wants only one insole, he or she may elect to skip the scan of either the left or the right foot.

Once all images are acquired, the user can append additional information 616 to the images in the form of text (ASCII format), graphics (annotations to existing images or new images), or voice messages (MP3 format recordable through a PC microphone). In the preferred embodiment, the foot scan software then packages all user information, images, and appended files into a single file with a *.PAK file extension 617. This step allows all order information to be submitted to the orthotic provider 104 using a single file. It also permits the mail file importer 314 to locate orders in incoming email by searching for email attachments with the unique *.PAK extension. After the order information is packed by the foot scan software, the user may then submit 618 the order or elect to restart the scanning procedure. If the order is submitted, the data is stored locally and an attempt to transmit the order through a live internet connection is made 620. In the event no internet connection is available, the stored order data may be transmitted or emailed later. At this point, the user can choose to begin a new scan session 622 or exit the program 624 altogether.

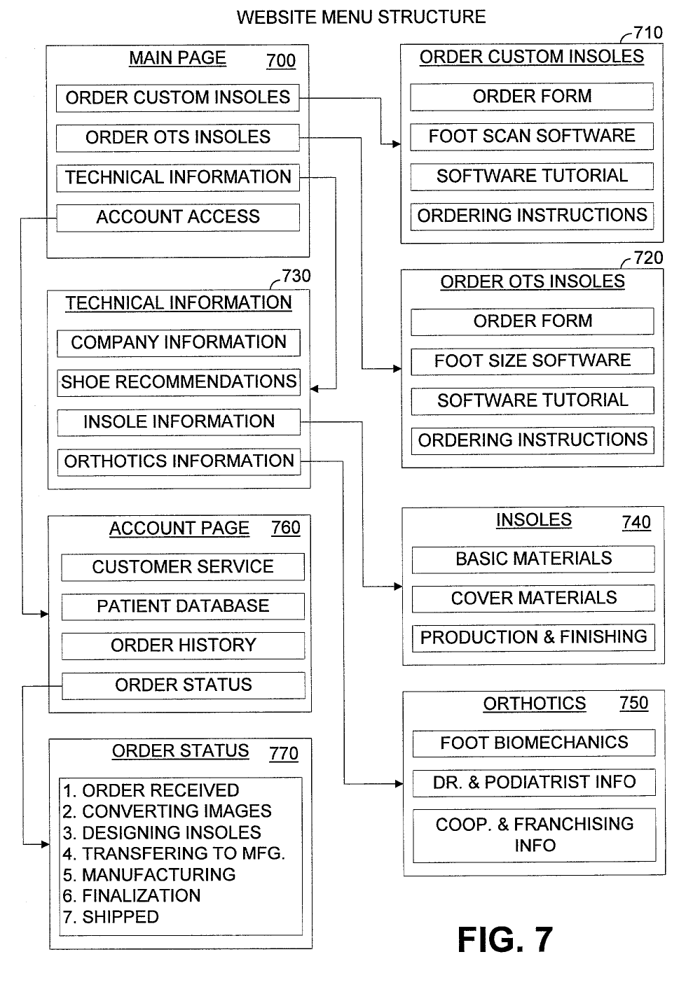

FIG. 7 depicts a simple representation of the menu structure of the preferred website through which customers may order custom orthotic insoles. From the main page 700 of the site, users can preferably select one of at least five different options, including, but not limited to: ordering custom insoles, ordering pre-fabricated, OTS insoles, obtaining technical information, obtaining company information, and accessing account information. Selecting the “Order Custom Insoles” option 710 directs users to a separate menu branch that provides additional information such as an online order form and instructions for placing an order online or via the foot scan software. The custom insole order page 710 also preferably provides instructions for downloading, installing, and using the foot scan software.

Selecting the “Order OTS Insoles” option 720 directs users to a different menu branch that provides equivalent information corresponding to the foot size software. That is, the OTS insole order page 720 includes an online order form and instructions for placing orders as well as instructions for downloading, installing, and using the foot size software. As mentioned above, the OTS insole order page may optionally include information on ordering foam boxes as an alternative method of capturing images of a customer's feet.

The technical information option 730 provides additional information on the company, on recommended shoes, on insole manufacturing, and on orthotics. The company information link may provide pertinent information such as company activities, current and future technologies used in manufacturing orthotic insoles, and contact information. The shoe recommendations link preferably offers information on the interactive role shoes and orthotics play and on the influence shoes have on orthotic functionality. This option may also have information or links to shoe manufacturers that produce footwear that will be appropriate for use with custom orthotics. The insole information option 740 preferably provides information on the types of materials used in manufacturing the custom orthotic insoles. Examples may include basic structural materials and covering materials such as EVA, cork, and leather. Descriptions of the materials will preferably include pros and cons to each material as well as a representative image and material properties such as density and hardness. Obviously, those skilled in the art will recognize the materials typically used in manufacturing orthotic insoles and the examples given above are offered by way of example and not by way of limitation. In addition to information on materials, the insole information option 740 preferably also includes information on production and finishing of the insoles, including the milling, trimming, and packaging operations.

Orthotic information 750 is also located under the technical information option 730. The orthotic information option 750 preferably contains information that is more medically technical, such as a review of foot biomechanics and the role orthotics play in correcting patient problems. The orthotic information option 750 also includes information for doctors and podiatrists, such as scientific information and business opportunities, including information on entering into a cooperative purchase agreement with the orthotics manufacturer.

Referring still to FIG. 7 and returning again to the main page options 700, authorized users may access account information 760 relating to prior orders, a patient database for examining past diagnoses and prescriptions, and the status of a current order. In the event users cannot locate the information they need on the website, the account information page 760 also provides customer service contact information. In checking the status of a current order 770, one of at least seven different states will be shown for any given order. These states include:

1. ORDER RECEIVED—Order has been successfully received and all relevant data and information has been submitted to the production database.

2. CONVERTING IMAGES—Grayscale images are in the process of being converted from a 2D array into a 3D model.

3. DESIGNING INSOLES—3D model being manipulated and, if applicable, prescription being incorporated to create a final insole model.

4. TRANSFERING TO MANUFACTURING—Cutting tool paths defined by 3D insole model and cutting instructions being transferred to the appropriate milling or cutting machine.

5. MANUFACTURING—Insoles being cut from raw stock.

6. FINALIZATION—Insole cover materials being bonded to base materials as well as final trimming and packaging.

7. SHIPPED—Item shipped and, if available, an appropriate tracking number is provided.

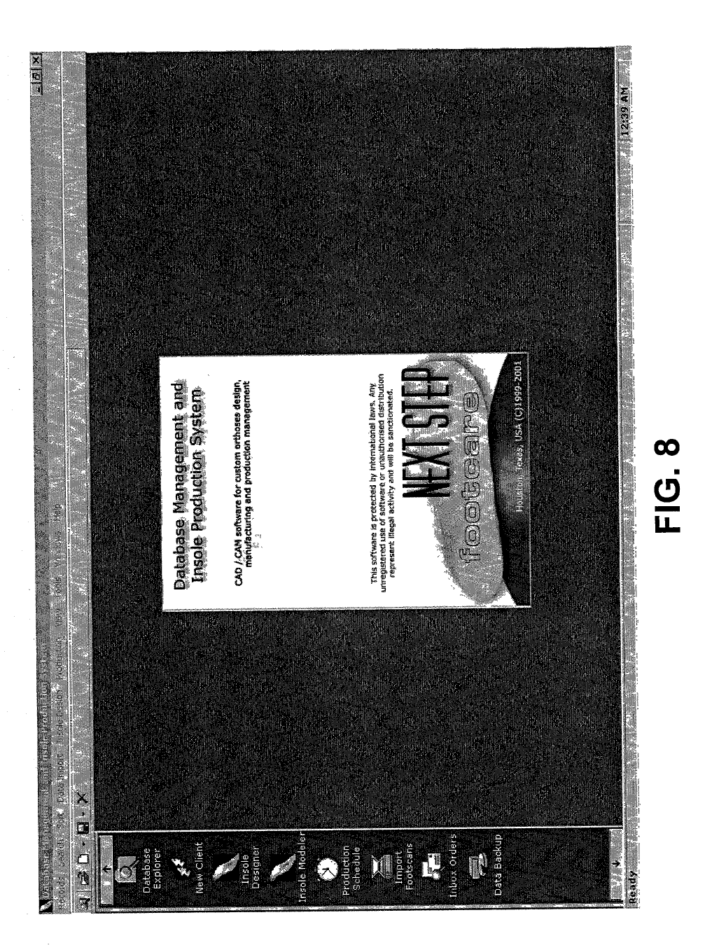

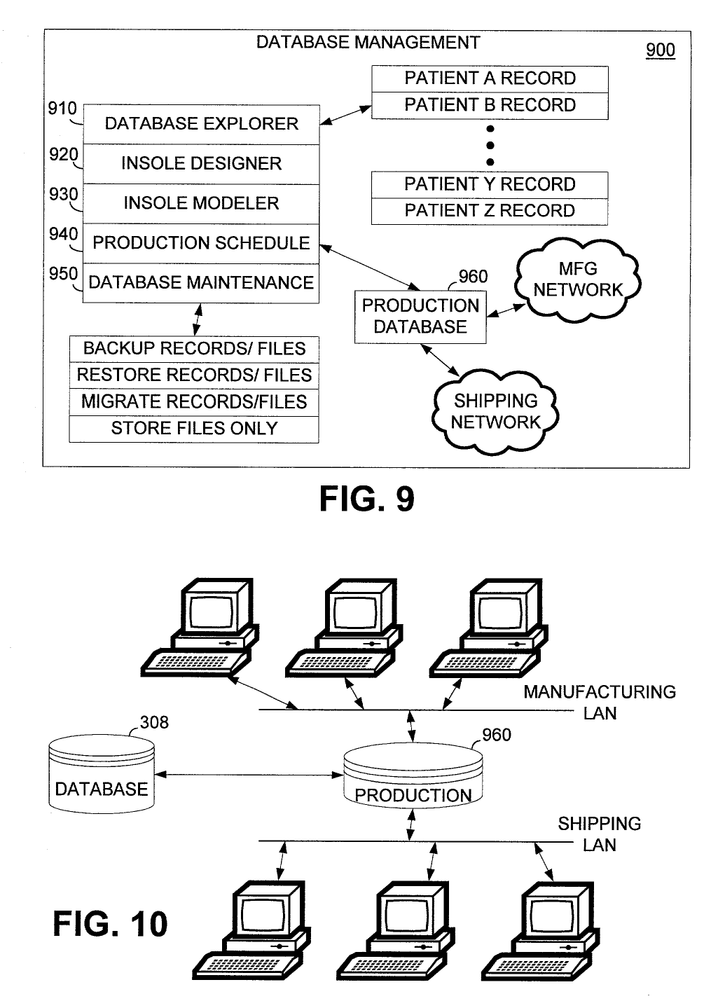

Now referring to FIG. 8, the order status information just described is readily available to customers and service representatives because of the centralized database environment in the preferred embodiment. As was shown in FIG. 3, the central production database 308 contains information on patients, patient records, and orders. This central production database 308 is managed using a Windows based database management software program. FIG. 8 shows a representative screen capture of the startup splash screen for this database management software. The icons in the explorer bar at the left side of the screen represent various functions that are reproduced in schematic form in FIG. 9.

In accordance with the preferred embodiment, the primary functions of the database management software 900 include a database explorer 910, an insole designer/converter 920, an insole modeler 930, a production schedule tool 940, and a database maintenance function 950. The insole designer 920 and insole modeler 930 were briefly discussed above and will be discussed in further detail below. The database explorer 910 provides access to individual records for each patient with an order on file. Each patient record includes information such as examinations and orthotic specifications. The precise contents of each client record will be discussed in further detail below.

The database maintenance utility 950 allows authorized users to move or backup relevant database records and files. In addition, the maintenance utility 950 also provides a database recovery tool that is useful for restoring files and records that may be lost due to a catastrophic disk drive failure. Further, because the image and data files for each record may be quite large, hard disk capacities may be pushed to their limits. To improve operating efficiency, older database files may be archived to remote locations or to CD-R and CD-RW discs using the “Store Files Only” function.

The production schedule function 940 provides real time access to a production database 960 to monitor design, production, and delivery events. The production schedule monitor 940 provides an overview on each received order and permits production schedule management for a certain day. After a client record is created in the production database 308, the production schedule database 960 is automatically updated with the new order. The Production Schedule database 960 is a separate database that is connected to the main production database 308. Every computer in the manufacturing and shipping networks can log onto the Production Schedule database 960. This feature is shown more clearly in FIG. 10, where computers in the manufacturing network are coupled to a manufacturing network or LAN. Similarly, computers in the shipping network are coupled to the shipping network or LAN. Every user in the system can update the production schedule database 960 from his or her station. For example, a milling machine operator can update the production database 960 after milling is finished or the outgoing delivery office can update the database 960 to indicate that a product has been delivered. Once the production database is updated with new information, all other users in the network can see the latest status. This approach may advantageously optimize production time (e.g. prioritizing tasks in the production procedure) and provide a clear status of all orders from receiving to delivery of a finished product.

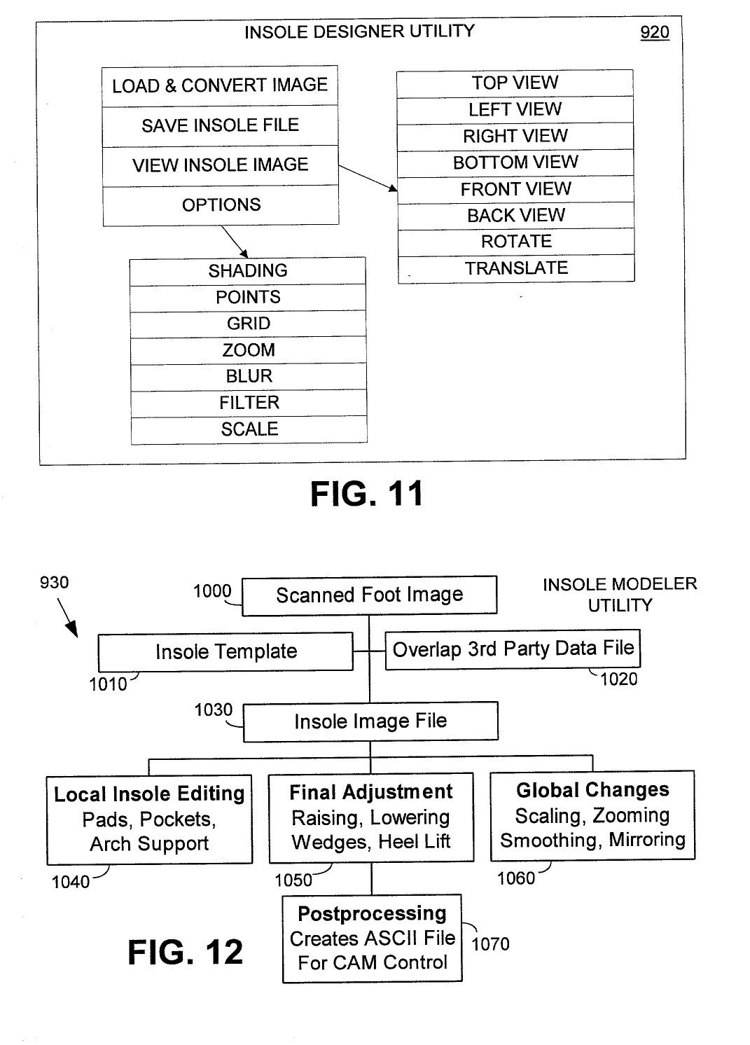

Referring now to FIG. 11, the Insole Designer Utility 920 within the production database management software 900 is a Windows based computer application primarily designed for conversion of a 2-D computer image of the foot into a 3-D vector record. While software applications of this kind are numerous, the Insole Image Designer 920 is designed exclusively for the conversion of foot images obtained using a commercially available flat bed scanner.

It is envisioned that the orthotics provider 104 will have the Insole Image Designer 920 at their disposal to convert foot images to a 3-D model that can subsequently be edited and modified to create a custom insole. In essence, the Insole Image Designer extrapolates grayscale values in the original image into depth values to create a 3D surface that matches the contours of the foot. This 3D surface, which represents the bottom surface of a foot, can subsequently be used to create the top surface of a new insole. The proprietary Insole Modeler 930 has been developed in conjunction with the Insole Image Designer 920 and allows for various types of manipulation to the insole model. The Insole Modeler 930 is discussed in greater detail below.

The Insole Image Designer preferably reads standard computer image files (e.g., jpeg, gif, tiff). The recommended scan resolution is 130-250 dots per inch (“DPI”). One inherent advantage to reading standard image file types is that it is possible to scan the foot at any computer location. The foot may be scanned at the manufacturer, a doctor's office, or even at the customer's home. To use the image, the Insole Image Designer 920 first converts the image into a grayscale Windows Bitmap format (if not already done so). Once read by the Insole Image Designer 920, the image can be viewed from various perspectives and can also be converted to the appropriate 3D insole file format (*.ICI), which is the standard file type readable by the Insole Modeler 930. Additional features of the Insole Image Designer 920 are shown in FIG. 11 and a representative screen capture of the Insole Image Designer software is shown in FIG. 13.

In addition to basic file conversion, the Insole Image Designer 920 also permits high-level image manipulation, such as viewing the image from different perspectives or viewing the image in shaded or wireframe format. Grids and points may also be displayed on the screen. The Insole Image Designer 920 also preferably permits image filtering such as blurring, sharpening, or other de-speckling effects to remove undesirable imperfections in the image. Lastly, the image may also be scaled along one or more axes.

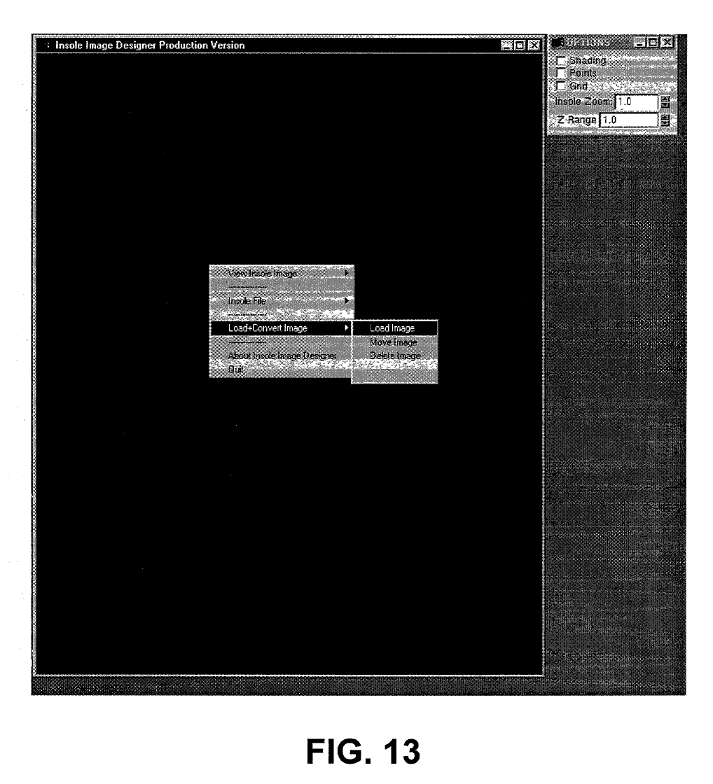

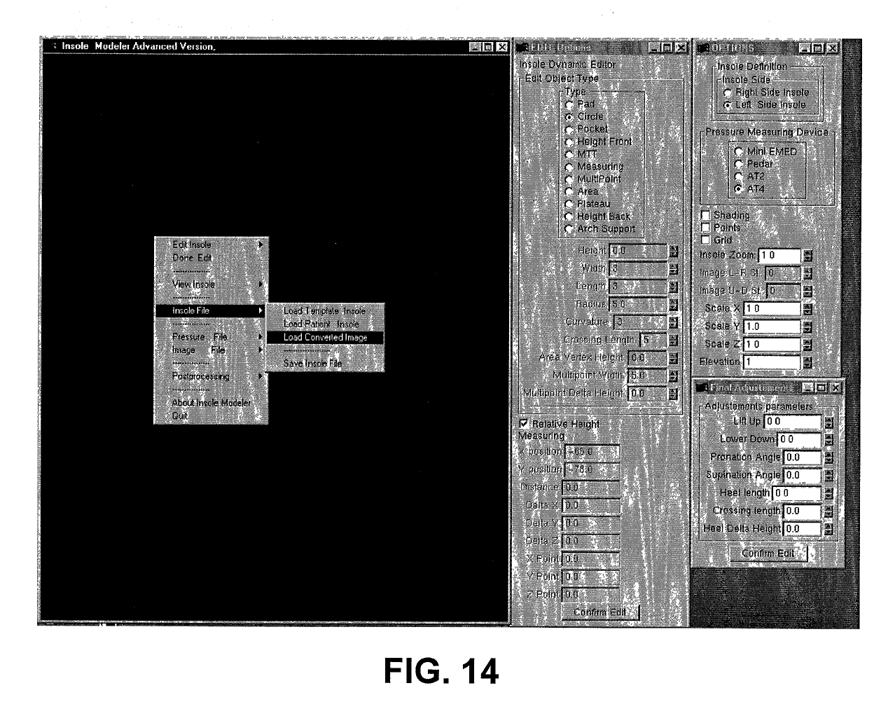

Referring to FIGS. 12 and 14, once the 3D ICI file is created by the insole designer 920, the insole manufacturer can import the file into the Insole Modeler 930. FIG. 14 shows a representative screen capture of the Insole Image Modeler 930 software. Like the Insole Image Designer 920, the Insole Modeler 930 is a Windows based software application that permits viewing and rendering of the foot model. However, the Insole Modeler 930 also allows manipulation of the insole model. FIG. 12 shows the general design process implemented using the Insole Modeler 930.

The design process begins in several different ways. One option is to load a scanned foot image 1000, which as above, is preferably in grayscale format. The scanned foot image file 1000 is preferably the patient (ICI) insole file that is generated by the Insole Image Designer software 920. As an alternative embodiment, it may be possible to incorporate the functionality of the Insole Designer 920 into the Insole Modeler 930 such that it would be possible to load a raw, scanned image directly into the Insole Modeler 930. Another option is to load a generic, unmodified insole template 1010. Generic templates of various sizes provide a useful starting point for the design of custom insoles. Another option is to load a third-party patient data file 1020, which may contain information about pressure data (dynamic forces and pressure distributions created in the patient's foot while walking), laser scan data, or medical DICOM files as mentioned above. Together, the insole file, image file, and data files may be saved into a single patient insole image file with a *.ICD extension 1030.

The ICD image file is then manipulated based on this compilation of information to create a custom insole. The Insole Modeler 930 has three main groups of editing functions: Edit 1040, which consists primarily of local editing, Final Adjustment 1050, which is mostly regional editing, and Global Changes 1060 such as scaling and smoothing functions. The Insole Modeler 930 also includes several option toolboxes that affect how the insole is viewed or edited. Once the final insole model is created, a Postprocessor 1070 creates machining instructions for an NC cutting machine.

The edit functions generally allow insole design personnel to add protrusions or carve out recesses in the insole to accommodate user specific requirements. For example, the PAD and MTT (Metatarsal) functions create pads on the surface of the insole that serve to redistribute forces in the patient's foot. Similarly, the CIRCLE and POCKET functions create recesses to alleviate pressure on injured or irregular surfaces of the foot. In addition to the four functions described, the EDIT menu in the Insole Modeler includes the following edit functions: Height Front, Height Back, Measuring, MultiPoint, Area, Plateau, and Arch Support.

The HEIGHT FRONT and HEIGHT BACK functions are designed for elevating parts of the insole, which may be used for eliminating surplus elements on the front or the back of the insole, thereby making the insole thinner or for creating shoe fillings in cases of amputated feet or other deformities. The MEASURING function calculates distances between points in the model and can preferably provide linear as well as coordinate distances in pixels and inches or millimeters. The MULTIPOINT function is a true 3D function for generating new surfaces defined by multiple points interconnected by lines. This function is useful for deepening or raising the edges of the insole, for creating channels for releasing pressure from the plantar fascia, or for designing a heel cup, which is important in cases of tendonitis, bursitis, and partial or total ruptures of the Achilles tendon. The AREA and PLATEAU functions are similar in that they are free form raised or recessed areas defined polygonally by setting points on the surface of the insole. The difference between the two is that in the AREA function, the recess or raised portion converges to a point whereas the plateau rises or falls to a flat surface. The ARCH SUPPORT function is one of the most commonly used functions in the Insole Modeler 930. The function is relatively self-explanatory and is used to add outer support for the longitudinal arch area.

The Final Adjustments Functions 1050 generally permit large-scale modifications to the insole. For example, the thickness of the insole is modified by the LIFT UP or LOWER DOWN functions while the lateral tilt is altered using the PRONATION or SUPINATION functions. The heel of the insole is defined by specifying the HEEL LENGTH, CROSSING LENGTH and HEEL DELTA HEIGHT parameters.

The Global Change functions 1060 allow modification to the insole as a whole. For example, the SMOOTHING function is used to eliminate uneven surfaces created during the scanning procedure or to smooth sharp edges created by local editing functions. The SCALING function allows the designer to change the scale of the insole along any or each of the three Cartesian coordinates (i.e., X, Y, or Z axes). The ZOOMING function permits insole modelers to view the insole from different perspectives and with different magnifications. Lastly, the MIRRORING function permits the copying of existing features about a user-defined mirror axis.

Once the insole designer is satisfied with the form of the insole, the Postprocessing Functions 1070 are invoked to create and view an ASCII output file that is readable by an NC cutting machine. The output file generated by the CREATE PP FILE function defines the tool path for the cutter on the NC machine. The VIEW NC TOOL PATH function allows the designer to view the tool path overlaid on the insole. In its current preferred embodiment, the Insole Modeler is configured to create one of several different postprocessor files: SAC file for SAC (Servo Automation Control) interface and NCD and NCP files for a GCODE interface, which supports both step and continuous mode machining. Each of these file formats has been implemented with positive results on a Techno Isel three-axis CNC milling machine.

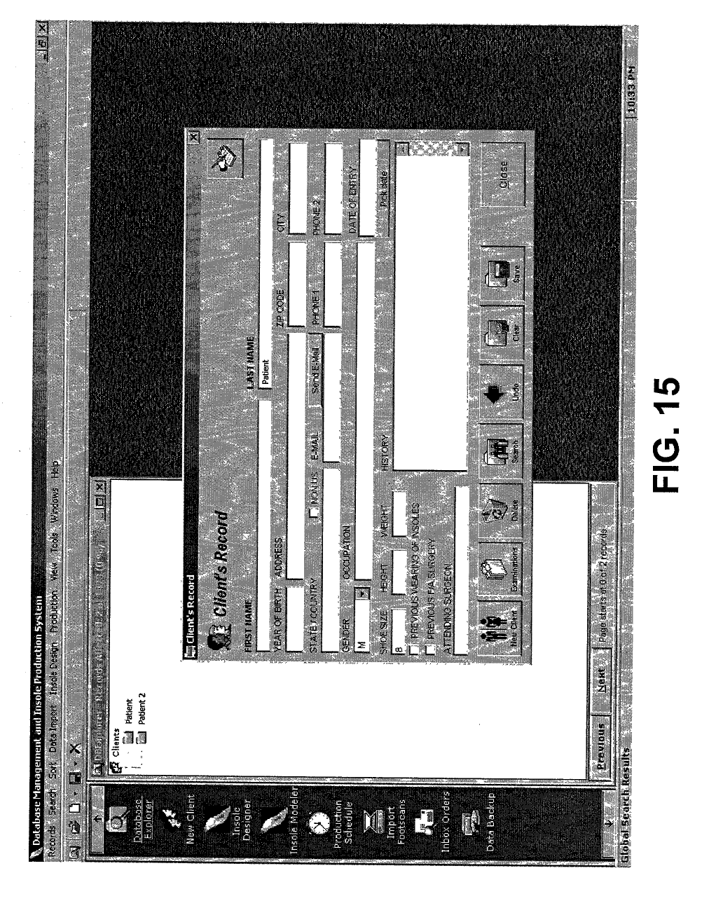

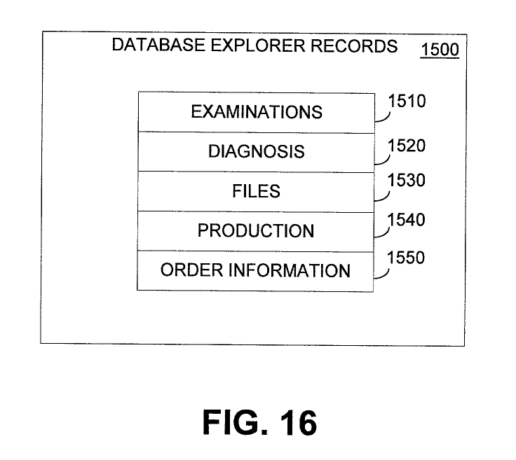

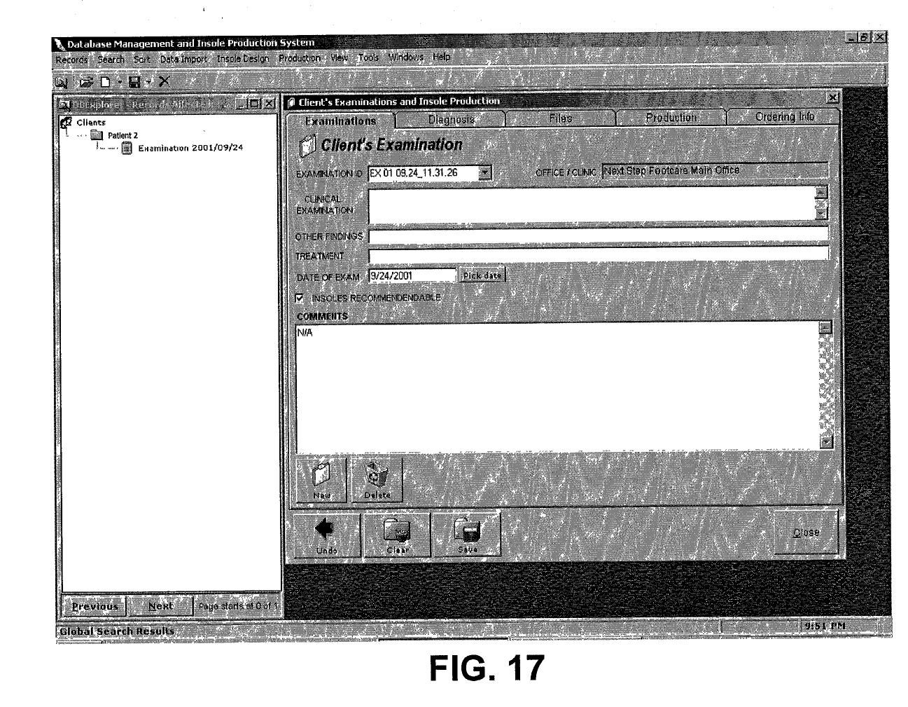

Referring now to FIGS. 15, 16, and 17 the client records 1500 in the production system database 308 will now be discussed. For each patient or client with an order submitted to the production database, a client record is created. A screenshot of an exemplary blank client record is shown in FIG. 15 and a screenshot of an existing client record is shown in FIG. 17. The client records are preferably browsed using the database explorer function 910 within the database management software 900. The client record preferably comprises important personal information about each patient such as name, address, gender, height, weight and shoe size and represent the root of the all customer information. As FIGS. 16 and 17 show, each record includes information on patient examinations 1510, diagnoses 1520, scanned images other patient data files 1530, orthotic production information 1540, and order information 1550. It should also be noted that the client records are fully searchable in the database explorer using different parameters, such as client names, diagnoses, or doctor names. A variety of other search terms are also feasible.

Client records can be created automatically or manually. The screenshot in FIG. 15 shows a representative form used to input client record information. Two different modules support automated creation of the records. The first module is mail file importer 314 discussed above. Once activated, the mail importer utility 314 searches the mail inbox database for messages that contain packed attachments with customer information. The other module searches specific network folders 318 for customer files (packed files with images, textual information, audio messages, and other information). The unpacking utility 316 unpacks these files to their original format and automatically creates a record in the production database using the patient information found with the incoming order.

Client records are organized based upon the customer examinations. Every customer/patient may have more than one exam. As new orders are imported, unpacking utility 316 checks if the customer/patient already exists in the production database 308. If a record already exists, the program warns the user and queries whether a new examination should be created under the existing record or a new record is to be opened. Storing multiple examinations under a common record makes patient/customer reevaluation much easier. One benefit to this approach is the ease with which doctors or designers can compare previous diagnoses and prescriptions. As FIG. 17 shows, the various sections of a client record are preferably presented in the database explorer as tabs on a tab strip. The examination tab 1510 contains fields that explain the clinical side of foot examination and allows practitioners to enter important notes or comments that can help during orthotic design.

Patient's diagnoses are separately stored onto a diagnosis tab 1520, which allows for convenient overview of patient foot conditions and related problems. To help practitioners write the diagnosis accurately, a database of diagnosis templates is preferably incorporated into this tab, which allows practitioners to pick a diagnosis (such as Calcaneus Valgus or Pes Cavus) from the list. New diagnoses may also be added.

The Files Tab 1530 makes it possible to review and manage a patient's files. Files stored in the database can be of different types and from different origins. For instance, and as discussed above, image files may be uploaded directly from a customer whereas a DICOM file may be transmitted to the database from a third party (e.g., a radiologist or a lab). Some of these files are directly used in the design (e.g. BMP, LST, ICD etc.) of the orthotic, while the others are used for navigation during design (DICOM). In either case, file conversion filters and a file viewer allow individual files to be viewed in the database explorer. Furthermore, files may be manually added to a patient record using the database explorer 910.

The Production tab 1540 offers technical information regarding orthotics to be made. After acquiring a patient's foot image with the Foot Scan software, a practitioner enters specific information regarding the type of orthotics to be made as well as the type of materials to be used. Practitioners also preferably enter corrective requirements (prescription) such as posting (pronation or supination wedges) or padding, etc. Information on this tab may be changed if required. In addition, the Production tab can be used to place or change the status of an order on the production schedule list.

Lastly, the Ordering Info Tab 1550 contains information regarding the original orthotic order. Information on this tab is “read only” and cannot be altered so as to maintain the integrity of the customer's initial request.

The above discussion is meant to be illustrative of the principles and various embodiments of the present invention. Numerous variations and modifications will become apparent to those skilled in the art once the above disclosure is fully appreciated. For example, it is entirely feasible that a fully automated orthosis design may be generated based on practitioner requirements and based on a history of ordering similar orthotic insoles. Pattern recognition and or neural networks may be used for this purpose. This type of automated design process may advantageously eliminate cost incurred during the manual 3D insole model design process. In addition, it may also be feasible to predict foot pressure distributions based on insole shape and material properties and biomechanical features of individual feet.

Other feasible features may include the possibility of creating base portions and top covers to the orthotics using an extrusion or other fabrication process as opposed to the milling operations heretofore described. Those skilled in the art of material processing and fabrication will recognize the potential manufacturing techniques that may be applied. Similarly, it may also be feasible to use motion pictures of a patient's gait to supplement the static images and other static data files contemplated herein. A gait analysis may advantageously provide further insight into a patient's requirements for a successful orthotic insole. It is intended that the following claims be interpreted to embrace all such variations and modifications.

What is claimed is:

1. An orthotic insole marketing and production system, comprising:
a receiver for receiving orthotic insole orders, each order comprising user information and scanned foot images;
a conversion utility for converting the scanned foot images into a three dimensional orthotic insole model;
a modeling utility for manipulating the three dimensional orthotic insole model;
a postprocessing utility for generating fabrication instructions from the manipulated orthotic insole model; and
a fabrication device that interprets the fabrication instructions to create a physical reproduction of the manipulated orthotic insole model;
wherein the physical reproduction created by the fabrication device is subsequently delivered to the user for use as an orthotic insole.

2. The system of claim 1 wherein orthotic insole orders further comprise a prescription based on a diagnosis from a medical practitioner.

3. The system of claim 1 further comprising:
a foot scan software program executable by orthotic insole customers to collect order information and aid users in scanning foot images;
wherein the foot scan software program creates and transmits orthotic insole orders to the system receiver.

4. The system of claim 3 wherein the foot scan software program packs all order information and scanned images into a single file prior to transmitting the orthotic insole order.

5. The system of claim 4 further comprising:
an unpack utility for extracting order information and scanned images from packed orthotic insole orders.

6. The system of claim 5 further comprising:
a production database for storing records of each orthotic insole customer;
wherein the unpack utility is further configured to submit order information and scanned images to the production database.

7. The system of claim 6 further comprising:
a public network accessible by customers, said network comprising information on ordering orthotic insoles and said network also providing access to the foot scan software.

8. The system of claim 7 wherein orthotic insole orders are transmitted by the foot scan software to the public network.

9. The system of claim 7 wherein orthotic insole orders are transmitted by the foot scan software to a private network within the orthotic insole production system.

10. A method of producing custom orthotic insoles, comprising:
receiving into a computer system an order for custom orthotic insoles; each order comprising scanned images of a patient's foot and instructions on customizing the orthotic insole;
converting the scanned images into three dimensional orthotic insole computer models;
adding features to the orthotic insole computer model according to the instructions for customizing the orthotic insole;
generating fabrication instructions for creating a physical replica of the orthotic insole computer model; and
fabricating a physical replica of the orthotic insole computer model using the fabrication instructions.

11. The method of claim 10 wherein the top surface of the orthotic insole computer model is created from the foot computer model.

12. The method of claim 11 wherein the instructions on customizing the orthotic insole are prescription instructions from a medical practitioner.

13. The method of claim 12 further comprising:
creating a patient record in a production database for each customer that has placed an order for custom orthotic insoles; and
storing all order information with the corresponding patient record;
wherein all order information is retrievable from the production database.

14. The method of claim 13 wherein patient record information within the production database is viewable using a production database explorer software program.

15. The method of claim 14 further comprising:
receiving data from a foot pressure measuring device reflecting pressure distributions on the foot of a customer ordering orthotic insoles;
overlaying pressure data onto the orthotic insole computer model;
adding features to the orthotic insole computer model to redistribute pressures on the customers foot.

16. The method of claim 14 further comprising:
receiving data from a medical imaging device reflecting the internal structure of the foot of a customer ordering orthotic insoles;
adding features to the orthotic insole computer model based on the data from the medical imaging device.

17. The method of claim 14 further comprising:
receiving data from a laser scanning device reflecting a 3D model of the foot of a customer ordering orthotic insoles;
adding features to the orthotic insole computer model based on the data from the laser scanning device.

18. A method of ordering custom orthotic insoles, comprising:
acquiring a computer image of a foot using an electro-optic scanner;
transmitting the image and custom fabrication instructions to an orthotic insole manufacturer;
wherein the image and custom fabrication instructions are used by the orthotic insole manufacturer to create a computer model of an orthotic insole from which custom orthotic insoles are manufactured.

19. The method of claim 18 further comprising:
downloading and executing a foot scan software program from the orthotic insole manufacturer;
inputting user information in response to queries from the foot scan software; and
acquiring computer foot images by following instructions from the foot scan software.

20. The method of claim 19 further comprising:
submitting the order for custom orthotic insoles from the foot scan software.

21. The method of claim 19 further comprising:
submitting the order for custom orthotic insoles by emailing an order file generated by the foot scan software to the orthotic insole manufacturer.

22. The method of claim 18 wherein the order is placed by the end user.

23. The method of claim 18 wherein the order is placed for the end user by an authorized practitioner.

24. The method of claim 23 wherein the authorized practitioner is a medical doctor and the custom fabrication instructions are in the form of a prescription generated in response to a medical diagnosis.

25. A method of ordering non-prescription, prefabricated insoles, comprising:
downloading foot sizing software from an insole provider network;
executing the foot sizing software to determine a correlated insole size to be used with a foot;
transmitting the correlated insole size to the insole provider;
wherein the correlated insole size is used by the insole provider to locate and deliver correctly sized orthotic insoles.

26. The method of claim 25 wherein the network is an internet website.

27. The method of claim 25 wherein the step of executing the foot sizing software to determine a correlated insole size to be used with a foot further comprises:
printing a diagram that includes a plurality of insoles sizes;
comparing a foot size to the plurality of insole sizes on the printed diagram; and
determining the insole size that most closely matches the foot size.

28. A method of producing a custom orthotic insole, comprising:
receiving into a computer system an order for a custom orthotic insole; each order comprising a scanned image of a customer's foot;
converting the scanned image into a three dimensional orthotic insole computer model;
generating fabrication instructions for creating a physical replica of the orthotic insole computer model; and
fabricating a physical replica of the orthotic insole computer model using the fabrication instructions.

29. The method of claim 28 further comprising:
receiving modification instructions with the order for a custom orthotic insole;
adding features to the orthotic insole computer model according to the modification instructions.

30. The method of claim 29 wherein the instructions on fabricating the orthotic insole are prescription instructions from a medical practitioner.

31. An orthotic insole marketing and production system, comprising:
a receiver for receiving orthotic insole orders, each order comprising user information and scanned foot images;
a conversion utility for converting the scanned foot images into a three dimensional orthotic insole model;
a postprocessing utility for generating fabrication instructions from the manipulated orthotic insole model; and
a fabrication device that interprets the fabrication instructions to create a physical reproduction of the orthotic insole model.

32. The system of claim 31 wherein the physical reproduction created by the fabrication device is subsequently delivered to the user for use as an orthotic insole.

33. The system of claim 32 further comprising a modeling utility for altering the three dimensional orthotic insole model.

34. The system of claim 33 wherein orthotic insole orders further comprise customization instructions.

35. The system of claim 34 wherein the customization instructions are prescriptions based on a diagnosis from a medical practitioner.

36. The system of claim 35 further comprising: a foot scan software program executable by orthotic insole customers to collect order information and aid users in scanning foot images.

37. The system of claim 36 wherein the foot scan software program creates and transmits orthotic insole orders to the system receiver.

38. The system of claim 36 wherein the foot scan software creates and saves orthotic insole orders to a local memory device, and wherein said orders are subsequently submitted to the system receiver.
